(19) United States
(12) Patent Application Publication
(10) Pub. No.: US 2016/0283911 A1
(43) Pub. Date: Sep. 29, 2016

(54) MULTI-PROGRAM SCHEDULING PLATFORM WITH AVAILABILITY INDICATORS

(71) Applicant: SJ MedConnect, Inc., Santa Clara, CA (US)

(72) Inventors: Jason Reminick, Santa Clara, CA (US); Suzanne Karan, Rochester, NY (US)

(21) Appl. No.: 14/669,362

(22) Filed: Mar. 26, 2015

(51) Int. Cl. G06Q 10/10

(52) U.S. Cl. CPC G06Q 10/1095

(57) ABSTRACT

A system and method for scheduling a plurality of event programs, including: generating a schedulee calendar for each of a set of schedulees of the event programs, each schedulee calendar depicting one or more sets of event slots for each of the event programs; generating an indicator of a relative availability for each set of event slots in each schedulee calendar; and serving the respective schedulee calendars to a set of respective schedulee clients such that indicators enable the respective schedulees to select among the event programs based on the relative availabilities.

### BACKGROUND

Organizations, e.g., schools, businesses, government agencies, etc., can hold event programs that can be scheduled by interested individuals. For example, a professional school can hold an interview event program for interviewing applicants to the professional school. Similarly, a businesses or other type of institution can hold an interview event program for interviewing job applicants. Interested individuals can schedule an event program by communicating directly with the organization holding the event program. For example, professional school applicants can schedule interview slots in an interview event program held by a professional school by communicating directly with the professional school. An interested individual can schedule with a number of a similar event programs. For example, medical students applying for residency positions can schedule interview slots in a number of interview event programs held by a number of different residency programs in their specialty of choice by communicating directly with each residency program in the affiliated institution.

### SUMMARY

In general, in one aspect, the invention relates to a platform for scheduling a plurality of event programs. The platform can include: a calendar module that generates a schedulee calendar for each of a set of schedulees of the event programs, each schedulee calendar depicting one or more sets of event slots for each of the event programs along with an indicator of a relative availability for each set of event slots; and an access module that enables the schedulees to access the respective schedulee calendars using a set of respective schedulee clients such that indicators enable the respective schedulees to select among the event programs based on the relative availabilities.

In general, in another aspect, the invention relates to a method for scheduling a plurality of event programs. The method can include: generating a schedulee calendar for each of a set of schedulees of the event programs, each schedulee calendar depicting one or more sets of event slots for each of the event programs; generating an indicator of a relative availability for each set of event slots in each schedulee calendar; and serving the respective schedulee calendars to a set of respective schedulee clients such that indicators enable the respective schedulees to select among the event programs based on the relative availabilities.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates a multi-program scheduling platform in one or more embodiments.

FIG. 2 illustrates a schedulee calendar in one or more embodiments.

FIG. 3 illustrates a schedulee calendar in one or more embodiments depicting multiple event programs that can be scheduled by a schedulee.

FIG. 4 shows an information panel of a schedulee calendar providing a list of confirmed event programs.

FIG. 5 shows a popup window that appears in response to a schedulee selecting a day view of an event program.

FIG. 6 illustrates a method for scheduling a plurality of event programs in one or more embodiments.

FIG. 7 illustrates a computing system upon which portions of a multi-program scheduling platform can be implemented.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

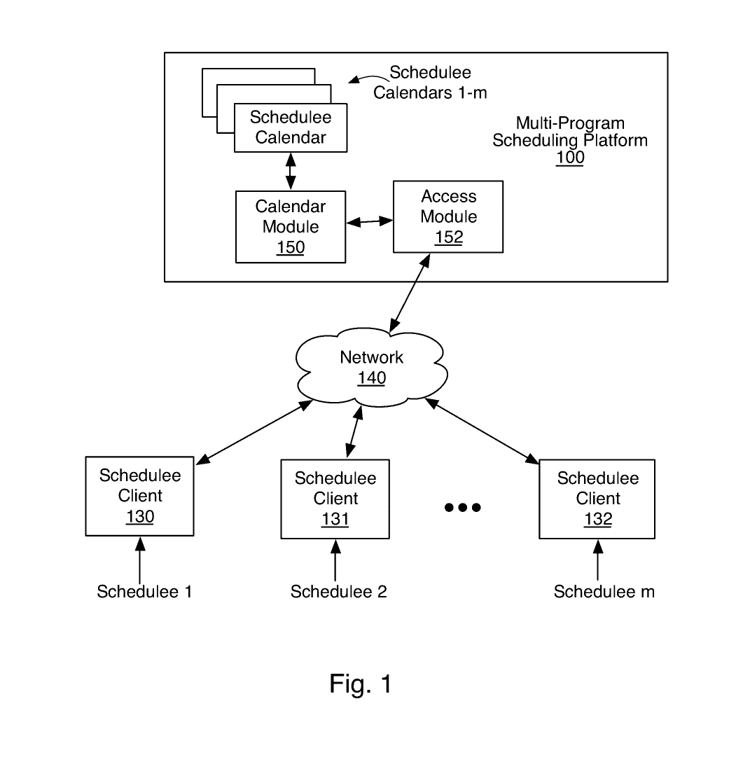

FIG. 1 illustrates a multi-program scheduling platform 100 in one or more embodiments. The multi-program scheduling platform 100 enables a set of schedulees 1-m, individuals, to schedule events slots in a plurality of event programs 1-n. There can be any number, n, of event programs 1-n and any number, m, of schedulees 1-m. Each event program 1-n can include multiple sets of event slots. One or more of the schedulees 1-m can seek to schedule event slots in more than one event program 1-n.

The multi-program scheduling platform 100 includes a calendar module 150 that generates a set of schedulee calendars 1-m for the respective schedulees 1-m of the event programs 1-n. Each schedulee calendar 1-m depicts one or more sets of event slots for the event programs 1-n along with an indicator of a relative availability for each set of event slots.

The multi-program scheduling platform 100 includes an access module 152 that enables the schedulees 1-m to access the respective schedulee calendars 1-m using a set of respective schedulee clients 130-132 via a network 140. The indicators enable the respective schedulees 1-m to select among the event programs 1-n based on the relative availabilities depicted by the indicators.

The event programs 1-n can be similar programs associated with different institutions. The event programs 1-n can be held at times of the year that coincide with traditional operations of institutions, e.g. the traditional school year for educational institutions or fiscal years for government or business institutions. In one embodiment, the event programs 1-n are interview days offered by different residency programs and the schedulees 1-m are fourth-year medical students seeking residency positions.

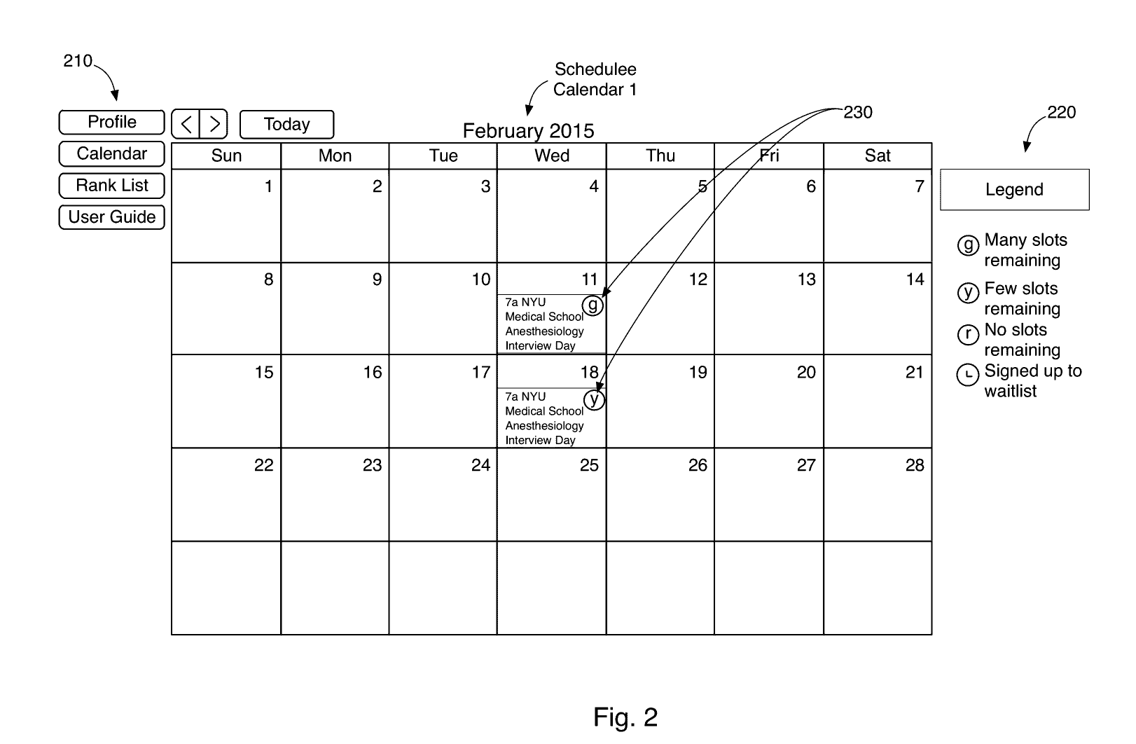

FIG. 2 illustrates the schedulee calendar 1 in one or more embodiments. The schedulee calendars 2-m can be substantially similar. The schedulee 1 can navigate to the schedulee calendar 1 by selecting a “Calendar” button in a navigation pane 210 displayed on the schedulee client 130. The navigation pane 210 can be displayed in the login account of the schedulee 1 on the multi-program scheduling platform 100. If the schedulee client 130 is, e.g., a desktop or laptop computer, then the schedulee 1 can use a pointing device, e.g., a mouse, to select the buttons in the navigation pane 210. If the schedulee client 130 is a mobile device then the schedulee 1 may touch select buttons in the navigation pane 210 via a touchscreen interface.

The schedulee calendar 1 in this example depicts an NYU Medical School Anesthesiology event program with a set of event slots on the 11th and a set of event slots on the 18th of February 2015. The schedulee calendar 1 includes a set of indicators 230 that indicate the relative availability of the event slots on the 11th and the event slots on the 18th of February 2015.

In one or more embodiments, the indicators 230 are color-coded including a color green (g) that indicates a high availability of the corresponding event slots and a yellow color (y) that indicates a low availability of the corresponding event slots and a red color (r) that indicates no availability of the corresponding event slots. In this example, the indicators 230 indicate a high availability of the event slots on the 11th of February 2015 and a low availability of the event slots on the 18th of February 2015.

The indicators 230 can be coded in different shapes, sizes, patterns, etc., to indicate relative availability. The indicators 230 can be coded with animations to indicated relative availability.

The calendar module 150 can determine the indicators 230 by determining the number of available event slots on a given day and comparing that number to a threshold number. For example, more than S available event slots can correspond to a green indicator and less than S available event slots can be a yellow indicator. The number S can be customized to the event programs 1-n. The calendar module 150 can determine the indicators 230 by determining a percentage of the event slots for an event program currently available on a given day compared to the number originally created for that event program for that day. For example, if X event slots were originally created for the NYU event program on the 11th of February 2015 and Y of those event slots are currently available, then the calendar module 150 can determine the indicator 230 for the 11th of February 2015 by comparing Y/X to a set of percentage thresholds. For example, a current Y/X exceeding 75% can correspond to many slots remaining and a current Y/X under 25% can correspond to few slots remaining.

The calendar module 150 can update the indicators 230 in real-time in response to scheduling activities by the schedulees 1-n. For example, scheduling activities by the schedulees 2-n via the schedulee calendars 2-m can cause the green indicator 230 on the 11th of February 2015 to change to yellow. This can cause the schedulee 1 to prioritize scheduling for the NYU event program over other similar programs available to the schedulee 1.

The schedulee calendar 1 in one or more embodiments includes an information panel 220 that enables the schedulee 1 to decode the colors of the indicators 230. The schedulee calendar 1 in one or more embodiments can include an indicator, e.g., a small clock-face icon depicted in the information panel 220, that indicates that the schedulee 1 is signed up for a waitlist.

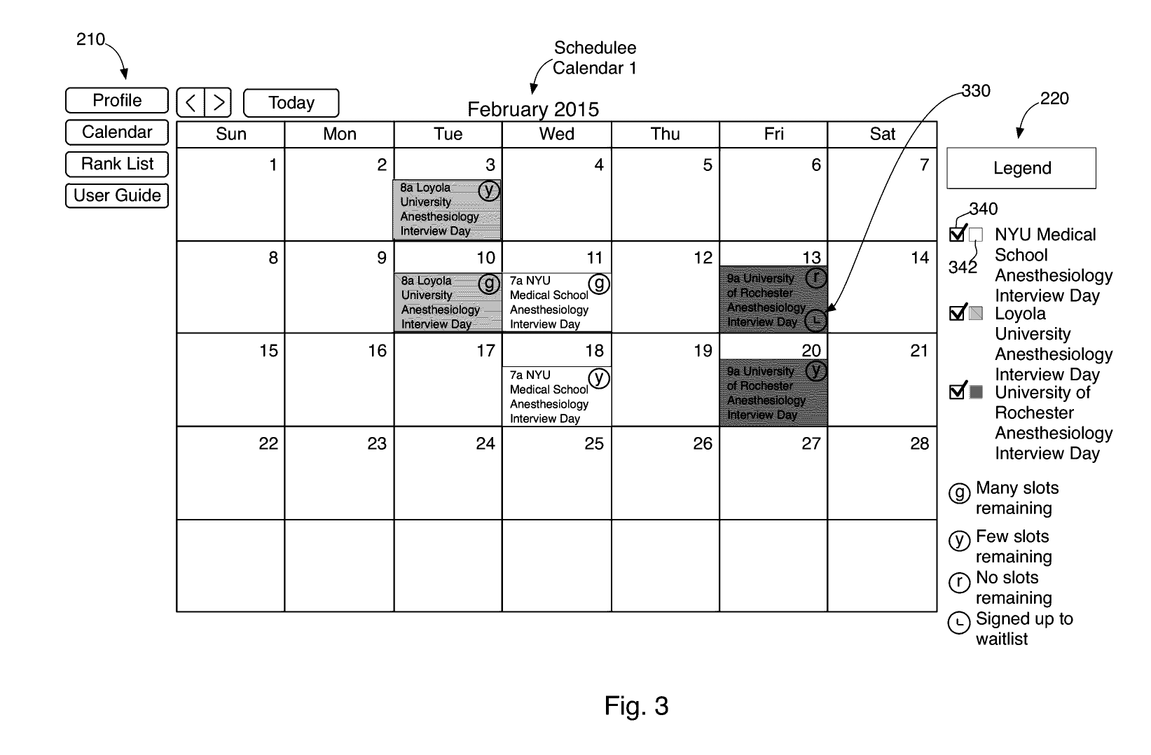

FIG. 3 illustrates the schedulee calendar 1 in one or more embodiments depicting multiple event programs that can be scheduled by the schedulee 1. The event programs in this example include the NYU Medical School Anesthesiology program with sets of event slots on the 11th and 18th of February 2015 along with sets of event slots for similar event programs at Loyola University on the 3rd and 10th and University of Rochester on the 13th and 20th of February 2015. The event slots on the 13th of February 2015 for the University of Rochester program have a red indicator, meaning no slots remaining, so the schedulee 1 has signed up for a waitlist in that program for that day as indicated by the indicator 330.

In one or more embodiments, the schedulee calendar 1 allows the schedulee 1 to sign up for a waitlist only for dates with no event slots remaining. If an event slot opens up on a date for which the schedulee 1 has signed up for a waitlist, all of the schedulees 1-m on the waitlist are automatically sent an email from the program scheduling platform 100 informing them of a now available event slot on that date for which they may now sign up.

The information panel 220 in FIG. 3 lists each of the three event programs NYU, Loyola, Univ. of Rochester, along with a corresponding selector, e.g., a checkbox, and a corresponding color-coded indicator. The color-coded indicators in the information panel 220 have the same color as the corresponding event programs in the day views of the schedulee calendar 1. For example, the color-coded indicator 342 has the same color as the background color of the NYU event program depicted in the day views on the 11th and 18th of February 2015. The checkboxes in the information panel 220 enable the schedulee 1 to show and hide the corresponding event programs in the schedulee calendar 1. For example, the schedulee 1 has checked the checkbox 340 to show the NYU event program and has checked checkboxes to show the other two event programs.

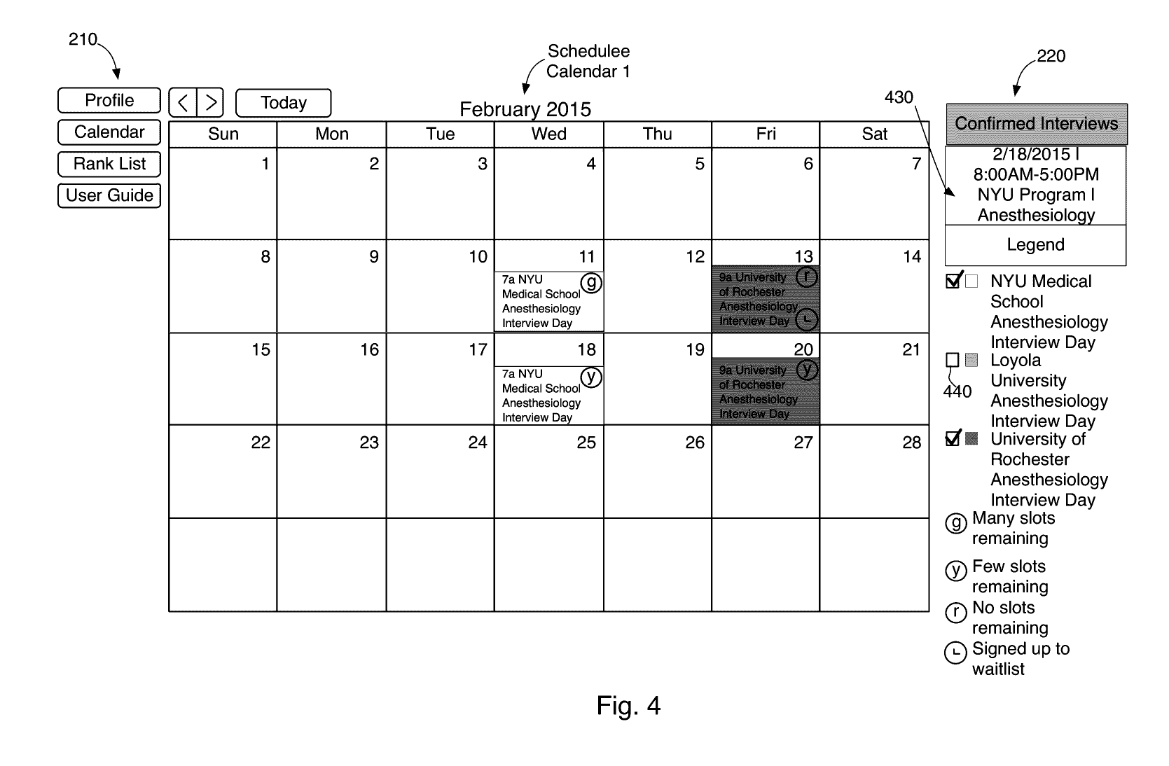

FIG. 4 shows the information panel 220 of the schedulee calendar 1 in one or more embodiments providing a list of confirmed event programs—in this example the scheduled slot on Feb. 18, 2015 in the NYU event program. The information panel 220 also shows the schedulee 1 has unchecked a checkbox 440 to hide the Loyola event program from the schedulee calendar 1 and so the Loyal event program is hidden in the current view of the schedulee calendar 1.

The schedulee 1 can schedule one or more of the event program depicted in the schedulee calendar 1 by selecting the corresponding day views, e.g., by clicking or touching the day views. For example, the schedulee 1 can schedule a slot on Feb. 18, 2015 by selecting that day view.

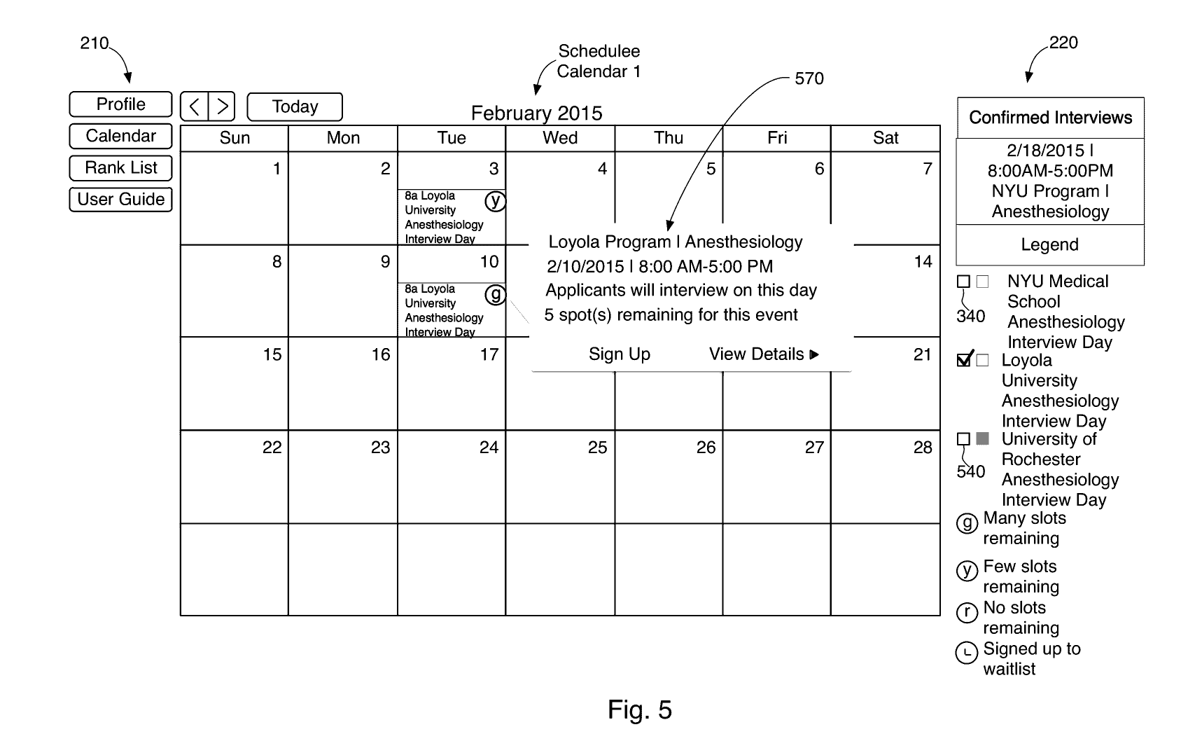

FIG. 5 shows a popup window 570 that appears over the schedulee calendar 1 in response to the schedulee 1 selecting the day view of Feb. 10, 2015 for the Loyola event program. The popup window 570 informs the schedulee 1 that 5 spots remain for that day in the Loyola event program and includes a “Sign Up” link that enables the schedulee 1 to conform for that day and a “View Details” link that enables the schedulee 1 to view details for the Loyola event program for that day. In response to the schedulee 1 selecting the Sign Up link in the popup window 570, a confirmation email is sent to the schedulee 1 and the confirmed Loyola event program appears in the information panel 220. This example also shows the schedulee 1 has unchecked the checkbox 340 and a checkbox 540 to hide the NYU and University of Rochester event programs, respectively.

The schedulee 1 can cancel the scheduled slot on Feb. 10, 2015 by selecting that day view again and in response a pop up window can appear that enables the schedulee 1 to cancel that day. In response to the schedulee 1 selecting a “Cancel” link in a popup window, an email is sent to the schedulee 1 confirming cancellation and the Loyola event program is removed from the information panel 220.

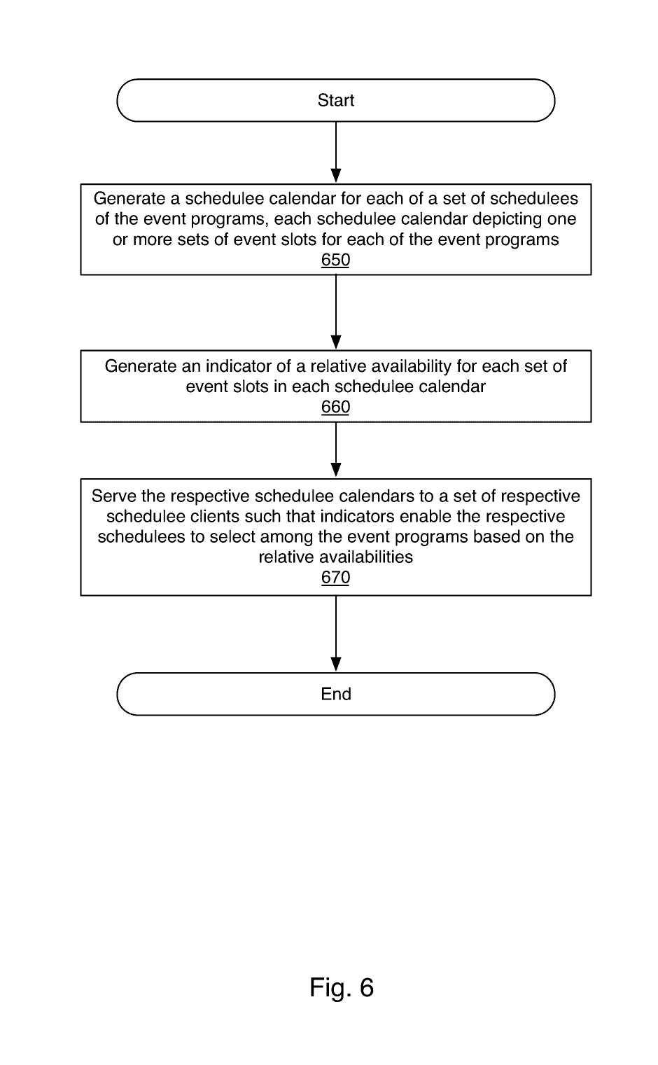

FIG. 6 illustrates a method for scheduling a plurality of event programs in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 6 should not be construed as limiting the scope of the invention.

At step 650, a schedulee calendar is generated for each of a set of schedulees of the event programs. Each schedulee calendar depicts one or more sets of event slots for each of the event programs. At step 660, an indicator of a relative availability is generated for each set of event slots in each schedulee calendar. At step 670, the respective schedulee calendars are served to a set of respective schedulee clients such that indicators enable the respective schedulees to select among the event programs based on the relative availabilities. The schedulee calendars can be served in response to requests, e.g., HTTP requests, from client devices used by the respective schedulees. The schedulee calendars can be served in web pages using web protocols.

The schedulee calendars 1-m can be generated on computing systems, e.g., servers, using web protocols so that they can be accessed and displayed on client devices using web browsers. The schedulee calendars 1-m can be displayed on client devices running a mobile app adapted to a mobile operating system of the client devices 130-132. The schedulee calendars 1-m can be generated using any combination of web protocols and mobile apps.

Embodiments of the invention may be implemented on a specialized computer system. Examples of such a computing system can include one or more mobile devices (e.g., laptop computer, smart phone, personal digital assistant, tablet computer, or other mobile device, game console), desktop computers, servers, blades in a server chassis, or any other type of computing device(s) that include at least the minimum processing power, memory, and input and output device(s) to perform one or more embodiments of the invention.

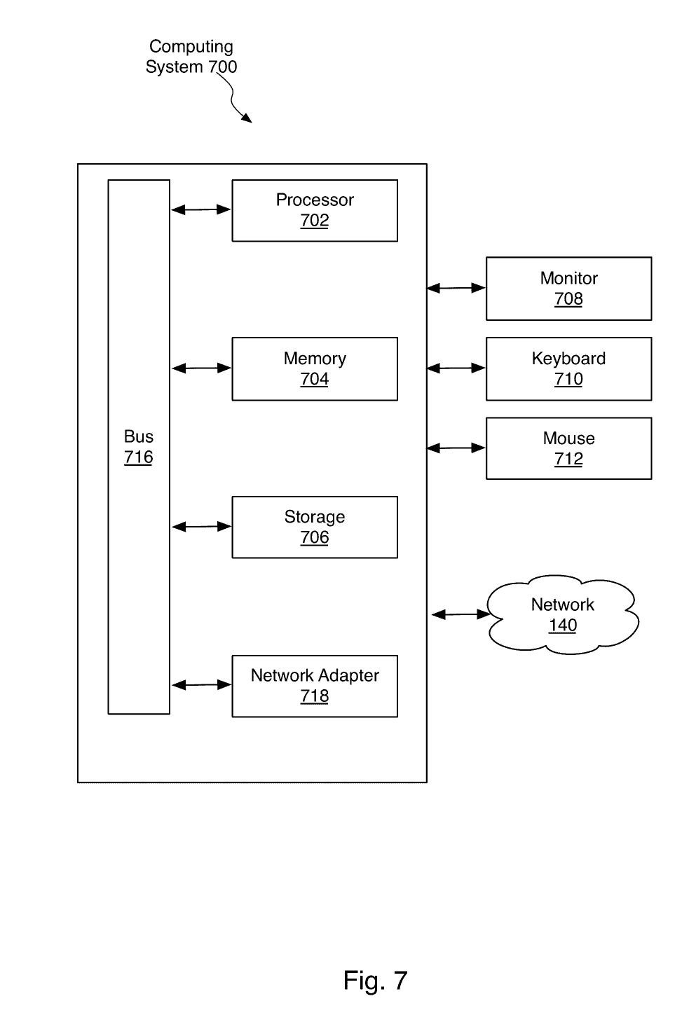

FIG. 7 illustrates a computing system 700 upon which portions of the multi-program scheduling platform 100 can be implemented. The calendar module 150 and the access module 152 and the schedulee calendars 1-m, along with associated login accounts and data structures and logic can be implemented in code running on the computing system 700. The schedulee clients 130-132 can be implemented in code on similar mobile or desktop/laptop computing systems.

The computing system 700 includes one or more computer processor(s) 702, associated memory 704 (e.g., random access memory (RAM), cache memory, flash memory, etc.), one or more storage device(s) 706 (e.g., a hard disk, an optical drive such as a compact disk (CD) drive or digital versatile disk (DVD) drive, a flash memory stick, etc.), a bus 716, and numerous other elements and functionalities. The computer processor(s) 702 may be an integrated circuit for processing instructions. For example, the computer processor(s) may be one or more cores or micro-cores of a processor. The computing system 700 may also include one or more input device(s), e.g., a touchscreen, keyboard 710, mouse 712, microphone, touchpad, electronic pen, or any other type of input device. Further, the computing system 700 may include one or more monitor device(s) 708, such as a screen (e.g., a liquid crystal display (LCD), a plasma display, touchscreen, cathode ray tube (CRT) monitor, projector, or other display device), external storage, input for an electric instrument, or any other output device. The computing system 700 may be connected to the network 140 (e.g., a local area network (LAN), a wide area network (WAN) such as the Internet, mobile network, or any other type of network) via a network adapter 718.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A platform for scheduling a plurality of event programs, comprising:
a calendar module that generates a schedulee calendar for each of a set of schedulees of the event programs, each schedulee calendar depicting one or more sets of event slots for each of the event programs along with an indicator of a relative availability for each set of event slots; and
an access module that enables the schedulees to access the respective schedulee calendars using a set of respective schedulee clients such that indicators enable the respective schedulees to select among the event programs based on the relative availabilities.

2. The platform of claim 1, wherein the indicators are color-coded according to a set of colors each indicating a level of the relative availability.

3. The platform of claim 2, wherein the colors include a color that indicates a relatively high availability and a color that indicates a relatively low availability and a color that indicates no availability.

4. The platform of claim 1, wherein each schedulee calendar includes an information panel that enables the respective schedulee to decode the indicators.

5. The platform of claim 1, wherein the indicators include a waitlist indicator that indicates the corresponding schedulee is on a waitlist for the corresponding event slots.

6. The platform of claim 1, wherein the indicators are displayed in a set of day views of the schedulee calendars that correspond to the event programs.

7. The platform of claim 1, wherein a set of day views in the schedulee calendars are color-coded according to a set of colors each indicating a corresponding one of the event programs.

8. The platform of claim 7, wherein each schedulee calendar includes an information panel that enables the corresponding schedulee to decode the color-codes in the day views.

9. The platform of claim 1, wherein each schedulee calendar includes a control panel that enables the corresponding schedulee to selectively hide individual ones of the event programs depicted in the schedulee calendar.

10. The platform of claim 9, wherein the control panel includes a selector for each event program and a color-code for each selector that correspond to the color-codes of the event programs.

11. A method for scheduling a plurality of event programs, comprising:
generating a schedulee calendar for each of a set of schedulees of the event programs, each schedulee calendar depicting one or more sets of event slots for each of the event programs;
generating an indicator of a relative availability for each set of event slots in each schedulee calendar; and
serving the respective schedulee calendars to a set of respective schedulee clients such that indicators enable the respective schedulees to select among the event programs based on the relative availabilities.

12. The method of claim 11, wherein generating an indicator comprises generating a color-coded indicator according to a set of colors each indicating a level of the relative availability.

13. The method of claim 12, wherein the colors include a color that indicates a relatively high availability and a color that indicates a relatively low availability and a color that indicates no availability.

14. The method of claim 11, wherein each schedulee calendar includes an information panel that enables the respective schedulee to decode the indicators.

15. The method of claim 11, wherein the indicators include a waitlist indicator that indicates the corresponding schedulee is on a waitlist for the corresponding event slots.

16. The method of claim 11, wherein the indicators are displayed in a set of day views of the schedulee calendars that correspond to the event programs.

17. The method of claim 11, wherein a set of day views in the schedulee calendars are color-coded according to a set of colors each indicating a corresponding one of the event programs.

18. The method of claim 17, wherein each schedulee calendar includes an information panel that enables the corresponding schedulee to decode the color-codes in the day views.

19. The method of claim 11, wherein each schedulee calendar includes a control panel that enables the corresponding schedulee to selectively hide individual ones of the event programs depicted in the schedulee calendar.

20. The method of claim 19, wherein the control panel includes a selector for each event program and a color-code for each selector that correspond to the color-codes of the event programs.
